(19) United States
(12) Patent Application Publication
(10) Pub. No.: US 2023/0356938 A1
(43) Pub. Date: Nov. 9, 2023

(54) HYDRAULIC SYSTEM FOR REFUSE VEHICLES

(71) Applicant: Oshkosh Corporation, Oshkosh, WI (US)

(72) Inventors: Jerrod Kappers, Oshkosh, WI (US); Jeff Meyer, Oshkosh, WI (US); Les Schwartz, Owatonna, MN (US); Umang Patel, Oshkosh, WI (US); Derek Wente, Oshkosh, WI (US); Brian Schad, Oshkosh, WI (US); Eric Codega, Oshkosh, WI (US)

(21) Appl. No.: 18/312,213

(22) Filed: May 4, 2023

Related U.S. Application Data
(60) Provisional application No. 63/338,528, filed on May 5, 2022.

(51) Int. Cl. B65F 3/06; B62D 21/02; F15B 1/26; F15B 11/17

(52) U.S. Cl. CPC B65F 3/06; B62D 21/02; F15B 1/26; F15B 11/17; B65F 2003/0279

(57) ABSTRACT

A refuse vehicle includes a chassis, a body, and a hydraulic system. The body is coupled with the chassis and includes a first frame rail and a second frame rail. The hydraulic system includes a pump, a hydraulic cylinder, and a hydraulic line. The pump is configured to pressurize a fluid. The hydraulic cylinder is configured to receive the fluid and extend or retract. The hydraulic line is configured to fluidly couple with an outlet of the pump and an inlet of the hydraulic cylinder. The hydraulic line is configured to extend laterally through the first frame rail by fluidly coupling with a connector that extends through an opening in the first frame rail. A portion of the hydraulic line extends in a longitudinal direction between the first frame rail and the second frame rail from the connector to the hydraulic cylinder.

### CROSS-REFERENCE TO RELATED PATENT APPLICATION

This application claims the benefit of and priority to U.S. Provisional Application No. 63/338,528, filed May 5, 2022, the entire disclosure of which is incorporated by reference herein.

### BACKGROUND

The present disclosure relates generally to the field of refuse vehicles and in particular the structure of the body and refuse container of the refuse vehicle.

### SUMMARY

One implementation of the present disclosure is a refuse vehicle, according to some embodiments. In some embodiments, the refuse vehicle includes a chassis, a body, and a hydraulic system. In some embodiments, the body is coupled with the chassis and includes a first frame rail and a second frame rail spaced apart from each other in a lateral direction and extending in a longitudinal direction along a bottom of the body. In some embodiments, the hydraulic system includes a pump, a hydraulic cylinder, and a hydraulic line. In some embodiments, the pump is configured to pressurize a fluid. In some embodiments, the hydraulic cylinder is configured to receive the fluid and extend or retract. In some embodiments, the hydraulic line is configured to fluidly couple with an outlet of the pump and an inlet of the hydraulic cylinder. In some embodiments, the hydraulic line is configured to extend laterally through the first frame rail by fluidly coupling with a connector that extends through an opening in the first frame rail. In some embodiments, a portion of the hydraulic line extends in the longitudinal direction between the first frame rail and the second frame rail from the connector to the hydraulic cylinder.

In some embodiments, the hydraulic system includes multiple hydraulic lines that are fluidly coupled with the outlet of the pump. In some embodiments, two or more of the hydraulic lines are configured to extend laterally through corresponding connectors of the first frame rail by fluidly coupling with the corresponding connectors that extend through corresponding openings in the first frame rail. In some embodiments, a portion of the two or more of the hydraulic lines extend in the longitudinal direction between the first frame rail and the second frame rail from the corresponding connectors to two or more hydraulic cylinders.

In some embodiments, the hydraulic cylinder is configured to extend or retract to drive a lift arm of the refuse vehicle to perform a refuse operation of the refuse vehicle. In some embodiments, the hydraulic cylinder is a tailgate cylinder configured to extend or retract to drive a tailgate of the body to rotate between an open position and a closed position.

In some embodiments, the hydraulic line extends in the longitudinal direction between the first frame rail and the second frame rail from the connector to the hydraulic cylinder to provide clearance between the body and the chassis. In some embodiments, the body is configured to be coupled on multiple different chassis having different axle configurations without the hydraulic line interfering with components of the different chassis.

In some embodiments, the pump is a first pump for a commercial configuration of the refuse vehicle. In some embodiments, the first pump configured to couple with a second pump in series for a residential configuration of the refuse vehicle. In some embodiments, the second pump is configured to pressurize fluid for multiple functions specific to the residential configuration of the refuse vehicle.

In some embodiments, the hydraulic system further includes a hydraulic reservoir having an integrated filter positioned within an inner volume of the hydraulic reservoir. In some embodiments, the hydraulic reservoir is fluidly coupled with an inlet or suction of the pump and positioned on a laterally outwards side of a frame rail of the chassis that extends in the longitudinal direction.

In some embodiments, the chassis includes a first axle, and a pusher axle. In some embodiments, the first axle is coupled to the chassis and spaced laterally apart from the hydraulic reservoir. In some embodiments, the pusher axle is coupled to the chassis and spaced longitudinally apart from the first axle such that the pusher axle is positioned between the first axle and the hydraulic reservoir.

Another implementation of the present disclosure is a hydraulic system for a refuse vehicle, according to some embodiments. In some embodiments, the hydraulic system includes a pump, a hydraulic cylinder, and a hydraulic line. In some embodiments, the pump is configured to pressurize a fluid. In some embodiments, the hydraulic cylinder is configured to receive the fluid and extend or retract. In some embodiments, the hydraulic line is configured to fluidly couple with an outlet of the pump and an inlet of the hydraulic cylinder. In some embodiments, the hydraulic line is configured to extend laterally through a first frame rail of the refuse vehicle by fluidly coupling with a connector that extends through an opening in the first frame rail. In some embodiments, a portion of the hydraulic line extends in a longitudinal direction between the first frame rail and a second frame rail from the connector to the hydraulic cylinder.

In some embodiments, the first frame rail and the second frame rail are frame rails of a body of the refuse vehicle that extend in the longitudinal direction along a bottom of the body of the refuse vehicle. In some embodiments, the hydraulic system includes multiple hydraulic lines that are fluidly coupled with the outlet of the pump. In some embodiments, two or more of the hydraulic lines are configured to extend laterally through corresponding connectors of the first frame rail by fluidly coupling with the corresponding connectors that extend through corresponding openings in the first frame rail. In some embodiments, a portion of the two or more of the hydraulic lines extend in the longitudinal direction between the first frame rail and the second frame rail from the corresponding connectors to two or more of the hydraulic cylinders.

In some embodiments, the hydraulic cylinder is configured to extend or retract to drive a lift arm of the refuse vehicle to perform a refuse operation of the refuse vehicle. In some embodiments, the hydraulic cylinder is a tailgate cylinder configured to extend or retract to drive a tailgate of a body of the refuse vehicle to rotate between an open position and a closed position.

In some embodiments, the hydraulic line extends in the longitudinal direction between the first frame rail and the second frame rail from the connector to the hydraulic cylinder to provide clearance between a body and a chassis of the refuse vehicle. In some embodiments, the body is configured to be coupled on multiple different chassis having different axle configurations without the hydraulic line interfering with components of the multiple different chassis.

In some embodiments, the pump is a first pump for a commercial configuration of the refuse vehicle. In some embodiments, the first pump is configured to couple with a second pump in series for a residential configuration of the refuse vehicle. In some embodiments, the second pump is configured to pressurize fluid for multiple functions specific to the residential configuration of the refuse vehicle.

In some embodiments, the hydraulic system further includes a hydraulic reservoir having an integrated filter positioned within an inner volume of the hydraulic reservoir. In some embodiments, the hydraulic reservoir is fluidly coupled with an inlet or suction of the pump and positioned on a laterally outwards side of a frame rail of the chassis that extends in the longitudinal direction.

Another implementation of the present disclosure is a refuse vehicle including a body, a first frame rail and a second frame rail, and a hydraulic system, according to some embodiments. In some embodiments, the body is configured to define an inner volume for storing refuse. In some embodiments, the first frame rail and the second frame rail extend along a bottom of the body in a longitudinal direction. In some embodiments, the first frame rail and the second frame rail are spaced apart from each other in a lateral direction. In some embodiments, the hydraulic system includes a pump configured to pressurize a fluid. In some embodiments, the hydraulic system includes multiple hydraulic cylinders configured to receive the fluid and extend or retract. In some embodiments, the hydraulic system includes multiple hydraulic lines fluidly coupled with an outlet of the pump and inlets of the hydraulic cylinders. In some embodiments, the hydraulic lines are configured to extend laterally through the first frame rail by fluidly coupling with connectors that extend through openings in the first frame rail. In some embodiments, a portion of the hydraulic lines extend in the longitudinal direction between the first frame rail and the second frame rail from the connectors to the hydraulic cylinders.

In some embodiments, the hydraulic cylinders include at least one of a lift arm cylinder configured to drive a lift arm of the refuse vehicle to perform a refuse operation, or a tailgate cylinder configured to extend or retract to drive a tailgate of the refuse vehicle to rotate between an open position and a closed position. In some embodiments, the pump is a first pump for a commercial configuration of the refuse vehicle. In some embodiments, the first pump is configured to couple with a second pump in series for a residential configuration of the refuse vehicle. In some embodiments, the second pump is configured to pressurize fluid for multiple functions specific to the residential configuration of the refuse vehicle.

In some embodiments, the hydraulic system further includes a hydraulic reservoir having an integrated filter positioned within an inner volume of the hydraulic reservoir. In some embodiments, the hydraulic reservoir is fluidly coupled with an inlet or suction of the pump and positioned on a laterally outwards side of a frame rail of the chassis that extends in the longitudinal direction.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, according to an embodiment;

FIG. 2 is a top view of a chassis of a refuse vehicle according to an embodiment.

FIG. 3 is a perspective view of a fluid container, according to an embodiment;

FIG. 4A is a perspective view of a portion of a fluid container, according to another embodiment;

FIG. 4B is perspective view of a portion of the fluid container of FIG. 5A;

FIG. 5 is perspective view of a pump, according to an embodiment;

FIG. 6 is a perspective view of a pump, according to another embodiment;

FIG. 7 is perspective view of a pump assembly, according to an embodiment;

FIG. 8 is bottom view of a portion of an on-board refuse container, according to an embodiment;

FIG. 9 is bottom view of a portion of an on-board refuse container, according to another embodiment;

FIG. 10A is a perspective view illustrating hydraulic connectors that extend through frame rails, according to an exemplary embodiment;

FIG. 10B is another perspective view illustrating the hydraulic connectors of FIG. 10A, according to an exemplary embodiment;

FIG. 11 is a block diagram of a hydraulic system of the refuse vehicle of FIG. 1, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Refuse vehicles collect a wide variety of waste, trash, and other material from residences and businesses. Operators of the refuse vehicle transport the material from various waste receptacles within a municipality to a storage or processing facility (e.g., a landfill, an incineration facility, a recycling facility, etc.). The material from these waste receptacles is stored within the refuse container of the refuse vehicle. The refuse container includes a compactor to compact the material within the refuse container. As the refuse container receives material to compact, the material exerts a force on components within the refuse container, which may lead to structural degradation. To counteract these forces, structural members of different shapes and sizes are used which can add complexity to manufacturing.

According to an exemplary embodiment, a refuse vehicle includes a refuse container with a bottom wall. The refuse vehicle further includes a fluid container (e.g., a hydraulic reservoir) coupled to the bottom wall and at least one actuator fluidly coupled with the fluid container and configured to receive fluid to operate the at least one actuator. The actuator may be driven (e.g., hydraulically) to transition between a first position to a second position. The fluid container may include a filter and a bypass sensor. The fluid container is configured to reduce fluid volume necessary, increase space on a chassis, reduce failures by integrating the filter, and allow for remote monitoring. In some embodiments, the refuse vehicle also includes a first rail and a second rail coupled to the bottom and a plurality of pipes (e.g., conduits, tubular members, hoses, lines, etc.) fluidly coupled to the fluid container. The fluid pipes extend from the fluid container to between the first rail and the second rail and extend parallel to the first rail and second rail. The plurality of pipes is extended about the bottom wall in this manner to provide clearance or space for various axle configuration and to simplify the fluid container design, serviceability, and manufacturability of hydraulic or fluid components of the refuse vehicle.

In some embodiments, the refuse vehicle may include a pusher axle coupled to chassis and spaced laterally apart from first axle and a second axle so as to be positioned on the chassis between the first axle and second axle. The pusher axle facilitates distribution of load and enhances maneuverability of the refuse vehicle when in operation.

In some embodiments, the refuse vehicle may also include a first pump fluidly connected to the fluid container configured to drive or discharge the fluid from the fluid container to the actuators or other hydraulic components. The refuse vehicle may also include a second pump fluidly coupled to the first pump. The refuse vehicle as described herein may provide a variety of benefits including, but not limited to: (1) updating body plumbing to optimize space and provide clearance for various axle configurations, (2) forming a uniform body layout for various refuse vehicle designs, (3) reducing failure of a fluid container by integrating a filter within the fluid container, (4) improving body integration with standard chassis designs to reduce the need for custom chassis and (5) facilitating remote monitoring of filter bypass in the fluid container.

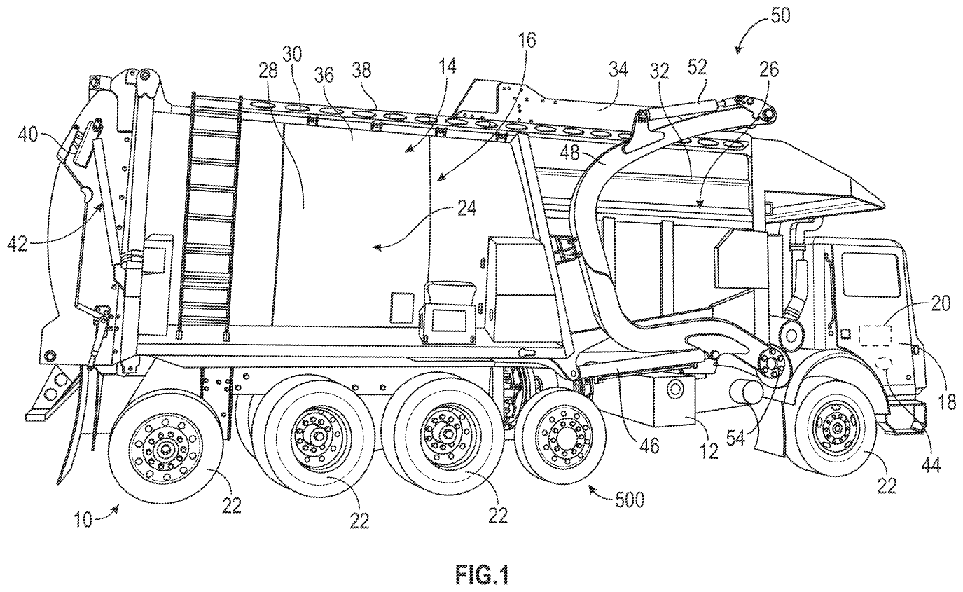

As shown in FIG. 1, a vehicle, shown as refuse vehicle 10 (e.g., garbage truck, waste collection truck, sanitation truck, a front end loading refuse vehicle, a side loading refuse vehicle, etc.), includes a chassis, shown as a frame 12, and a body assembly, shown as body 14, coupled to the frame 12. The body 14 defines an on-board refuse container 16 and a cab 18. The cab 18 is coupled to a front end of the frame 12 and includes various components to facilitate operation of the refuse vehicle 10 by an operator (e.g., a seat, a steering wheel, hydraulic controls, etc.) as well as components that can execute commands automatically to control different subsystems within the vehicle (e.g., computers, controllers, processors, etc.). The refuse vehicle 10 further includes a prime mover 20 coupled to the frame 12 at a position beneath the cab 18. The prime mover 20 provides power to a plurality of motive members, shown as wheels 22, and to other systems of the vehicle (e.g., a pneumatic system, a hydraulic system, etc.). A pair of wheels 22 may be coupled to an axle. The refuse vehicle 10 may include at least two axles. In some embodiments, the refuse vehicle 10 may include at least four axles, and may include five axles in various embodiments herein. The prime mover 20 may be configured to use a variety of fuels (e.g., gasoline, diesel, bio-diesel, ethanol, natural gas, etc.), according to various exemplary embodiments. According to an alternative embodiment, the prime mover 20 is one or more electric motors coupled to the frame 12. The electric motors may consume electrical power from an on-board storage device (e.g., batteries, ultra-capacitors, etc.), from an on-board generator (e.g., an internal combustion engine, high efficiency solar panels, regenerative braking system, etc.), or from an external power source (e.g., overhead power lines) and provide power to the systems of the refuse vehicle 10. According to some embodiments, the refuse vehicle 10 may be in other configurations than shown in FIG. 1. The refuse vehicle 10 may be in configurations such as a front loader, side loader, rear loader, or curb-sort recycling configuration.

According to an exemplary embodiment, the refuse vehicle 10 is configured to transport refuse from various waste refuse containers within a municipality to a storage or processing facility (e.g., a landfill, an incineration facility, a recycling facility, etc.). As shown in FIG. 1, the body 14 and on-board refuse container 16, in particular, includes a collection chamber 24 and a hopper 26. The collection chamber 24 is defined by a collection chamber first wall 28 (e.g., first wall, second wall, etc.), a collection chamber second wall (e.g., first wall, second wall, etc.), and a collection chamber top wall 30 (e.g., panel, cover, etc.). The hopper 26 is integrally formed with the collection chamber 24. The hopper 26 is defined by a hopper first wall 32 (e.g., first wall, second wall, a panel, a member, a planar surface, a surface, etc.), a hopper second wall (e.g., first wall, second wall, a panel, a member, a planar surface, a surface, etc.), and a hopper top wall 34 (e.g., panel, cover, lid, etc.). In some embodiments, the hopper first wall 32 is integrally formed with the collection chamber first wall 28 to form a first refuse container side wall shown as a first wall 36, the hopper second wall is integrally formed with the collection chamber second wall, so as to form a second wall (e.g., second refuse container side wall, etc.). The second wall is positioned opposite of the first wall 36. In some embodiment, the hopper top wall 34 is integrally formed with the collection chamber top wall 30 to form a refuse container top wall shown as top wall 38.

In some embodiments, the on-board refuse container 16 is shaped as a generally rectangular box having two transverse upper edges, two longitudinal upper edges, two transverse lower edges, and two longitudinal lower edges. The longitudinal edges extend along the length of the on-board refuse container 16 and the transverse edges extend across the length of the on-board refuse container 16, according to an exemplary embodiment. The body 14 further includes a tailgate 40 which is movably (e.g., rotatably, etc.) coupled to the on-board refuse container 16 and is positioned at the rear end of the body 14 and configured to pivot about pivot pins positioned along the top surface of the on-board refuse container 16.

According to the embodiment shown in FIG. 1, the on-board refuse container 16, collection chamber 24 and the hopper 26 are each positioned behind the cab 18. In some embodiments, the collection chamber 24 includes or defines a storage volume and the hopper 26 includes or defines a hopper volume. Loose refuse is initially loaded into the hopper volume by a manual (e.g., by hand) or automatic means (e.g., lifting system) and is thereafter compacted into the storage volume. The collection chamber provides temporary storage for refuse during transport to a waste disposal site or a recycling facility. In some embodiments, at least a portion of the on-board refuse container 16 and collection chamber extend over or in front of the cab 18.

According to an exemplary embodiment, the hopper volume is positioned at least partially within the tailgate 40. In other embodiments, the hopper volume is positioned between the storage volume and the cab 18 (i.e., refuse is loaded into a position behind the cab 18 and stored in a position further toward the rear of the refuse vehicle 10). Further, according to the embodiments shown in FIG. 1 refuse vehicles generally use a separate actuator and/or manual latch like assembly to secure the tailgate 40 to the refuse container 16 (e.g., rear body, refuse body, receptacle, etc.) of the refuse vehicle 10.

As shown in FIG. 1, the refuse vehicle 10 includes a tailgate actuator assembly, shown as a tailgate actuator 42 (e.g., hydraulic actuator, linear actuator, piston, etc.). The tailgate actuator 42 is configured to move the tailgate 40 about the pivot pins between an open position (e.g., a first tailgate position, etc.), away from the refuse container 16, and a closed position (e.g., a second tailgate position, etc.) in which the tailgate 40 is rotated into engagement with the refuse container 16.

The tailgate actuator 42 is rotatably coupled at a body end, shown as a first actuator end of the tailgate actuator 42 (e.g. first tailgate actuator end, etc.) to the body 14 and coupled (e.g., attached, fixed, welded, fastened, riveted, adhesively attached, bonded, pinned, bolted, screwed, etc.) to the tailgate 40 at a tailgate end, shown as second actuator end of the tailgate actuator 42 (e.g. a second tailgate actuator end, etc.). The tailgate actuator 42 is communicatively coupled to a processing unit shown as a processor 44. The processor 44 is configured to provide signals to selectively actuate the tailgate actuator 42. In some embodiments, the processor 44 monitors the position of the tailgate actuator 42 and the tailgate 40 (e.g., through communication with a position sensor within the tailgate actuator 42 and/or a position sensor within the tailgate 40). In some examples, the processor 44 communicates with a throttle and/or clutch of a vehicle transmission so that the tailgate actuator 42 cannot be deployed or otherwise adjusted outward from the fully-retracted position when the processor 44 receives an indication that the vehicle 10 is traveling over a threshold speed (e.g., 10 mph). In another example, the processor 44 may also receive signals from the sensors (e.g., proximity sensors, cameras, etc.) on the refuse vehicle 10 that indicate an unsafe condition for moving the on-board refuse container 16 towards the fully deployed position. In this example, the processor 44 may prevent adjustment of tailgate actuator 42 outward from the fully-retracted position. In yet other embodiments, the tailgate actuator 42 is controlled via a control level of a tailgate actuator 42 of the refuse vehicle 10.

In some embodiments, the tailgate actuator 42 can be controlled from within a central location, such as the cab 18 of the refuse vehicle 10. The cab 18 may include control panel including a series of inputs that can be actuated by a user to perform different operation. The control panel may also be in communication the processor 44 to provide signals and/or commands (e.g., command signals, etc.) that can be subsequently executed by the processor 44.

In some embodiments, the tailgate actuator 42 may be or include a hydraulic cylinder that is fluidly coupled to a hydraulic pump onboard the refuse vehicle 10. In other embodiments, the tailgate actuator 42 includes an electric actuator (e.g., linear actuator, etc.) and/or another actuator type. In operation, the actuator arm extends from the body 14 and out of the sleeve toward the tailgate 40 and causing the tailgate 40 to move upwardly and outwardly from the closed position to the open position. In the open position, the storage volume of the collection chamber 24 may be accessed such that the refuse may be removed. In some embodiments, the tailgate actuator 42 is a component of a hydraulic system of the refuse vehicle 10.

Referring still to FIG. 1, the refuse vehicle 10 includes a front end lift assembly 50 including a pair of arms 48 that are pivotally coupled at pivot 54. In some embodiments, the front end lift assembly 50 includes a first pair of lift actuators 46 (e.g., actuators, hydraulic cylinders, etc.) and a second pair of lift actuators 52 (e.g., actuators, hydraulic cylinders, etc.). In some embodiments, the first pair of lift actuators 46 are pivotally coupled at a first end with the body 14 and at a second end with a corresponding portion of the arms 48. In some embodiments, the second pair of lift actuators 52 are pivotally coupled at a first end with a corresponding portion of the arms 48 and pivotally coupled at a second end with a pivotal arm that is pivotally coupled with an end of the arm 48. The first pair of lift actuators 46 may extend or retract to drive the pair of arms 48 to raise and lower by rotating about the pivot 54. The second pair of lift actuators 52 may extend or retract to drive the pivotal arm to rotate about an end of the second pair of lift actuators 52.

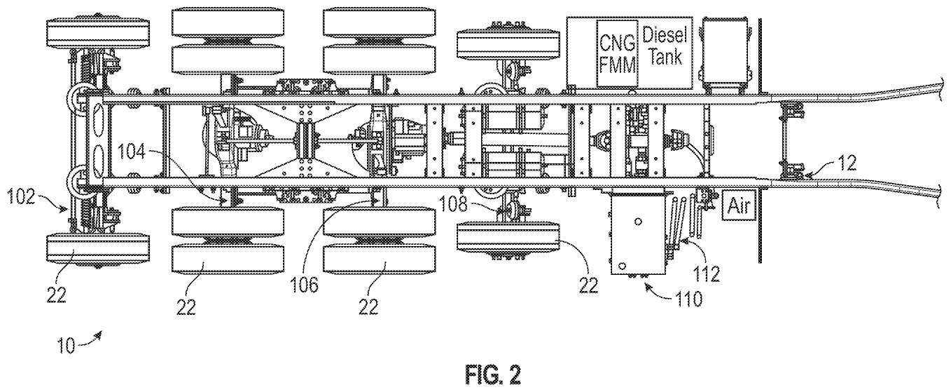

As shown in FIG. 2, the refuse vehicle 10 includes the frame 12. The frame 12 is configured to support the body 14 (as shown in FIG. 1). The frame 12 may be manufactured from a metal (e.g., steel, aluminum, etc.). In some embodiments, the frame 12 is manufactured from an alloy (e.g., aluminum alloy, nickel alloy, stainless steel alloy, etc.). The refuse vehicle includes a tag axle 102 (e.g., first axle, second axle, third axle, fourth axle, fifth axle, etc.). The tag axle 102 is coupled to one end of the frame 12. In some embodiments, (as seen in FIG. 1), the tag axle 102 is proximate to the tailgate 40. The tag axle 102 is coupled to a pair of wheels 22 and is configured to distribute the load of the on-board refuse container 16. In some embodiments, the tag axle 102 is retractable. The refuse vehicle 10 includes a first powered axle 104 (e.g., first axle, second axle, third axle, fourth axle, fifth axle, etc.). The first powered axle 104 is coupled to the frame 12 and spaced laterally apart from the tag axle 102. The first powered axle 104 is configured to facilitate movement of the refuse vehicle 10 when operated by an operator in the cab 18. The first powered axle 104 is coupled to at least one pair of wheels 22. In some embodiments, the first powered axle 104 is coupled to at least two pairs of wheels 22.

The refuse vehicle 10 includes a second powered axle 106. The second powered axle 106 is substantially similar to the first powered axle 104. The second powered axle 106 is coupled to the frame 12 and spaced laterally from the first powered axle 104. In some embodiments, the second powered axle 106 is coupled to the frame 12 such that the first powered axle 104 is positioned between the tag axle 102 and the second powered axle 106.

The refuse vehicle 10 includes a pusher axle 108 (e.g., a first axle, a second axle, a third axle, a fourth axle, a fifth axle, etc.). The pusher axle 108 is coupled to the frame 12 and spaced laterally apart from the second powered axle 106. The pusher axle 108 is coupled to a pair of wheels. The pusher axle 108 is configured to distribute the load of the on-board refuse container 16. Further, the pusher axle 108 increases maneuverability of the refuse vehicle 10. In some embodiments, the pusher axle 108 is retractable. In some embodiments, the pusher axle 108 is a third powered axle substantially similar to the first powered axle 104 and the second powered axle 106.

The refuse vehicle includes a fluid container 110. The fluid container 110 is configured to store fluid (e.g., hydraulic fluid, etc.,) which is then provided to various components of the refuse vehicle via a plurality of pipes (e.g., tubular members, lines, conduit, etc.), as described herein. In some embodiments, the components are actuators (e.g., hydraulic actuator, linear actuators, etc.). The fluid container 110 is coupled to the frame 12 and spaced laterally from the pusher axle 108. In some embodiments, the fluid container 110 is coupled proximate to the front end of the frame 12, for example near the cab 18, such that the pusher axle 108 is positioned between the second powered axle 106 and the fluid container 110. Beneficially from the arrangement of the fluid container 110, configurability with layouts for various frame and axle configurations is simplified, body integration with various frames manufactured is improved, location of components remains constant for various designs, and facilitates standardized designs for the fluid container 110 and the plurality of pipes, as described herein, for various designs. In some embodiments, the fluid container 110 includes at least one service pipe 112 (e.g., service hose, service conduit, service loop, hydraulic service loop, etc.). The service pipe 112 is configured to facilitate servicing of the fluid container 110. For example, an operator may drain the fluid within the fluid container 110 through the service pipe 112 when conducting service.

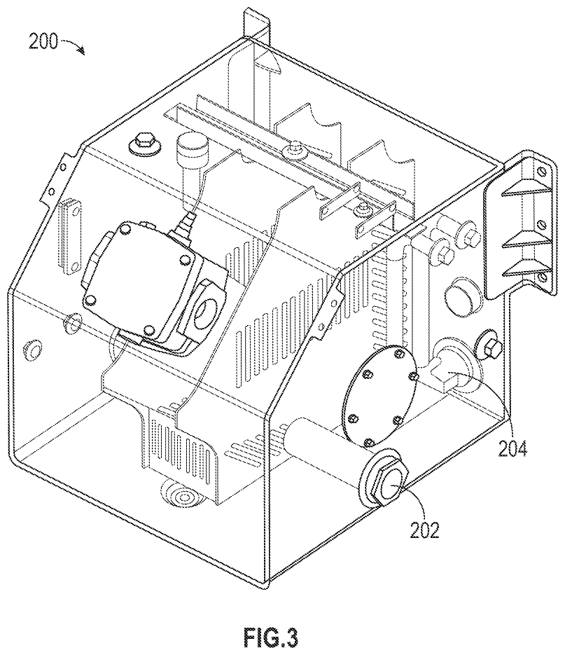

Referring to FIG. 3, a fluid container 200 (e.g., the fluid container 110), according to some embodiments is shown. The fluid container 200 is coupled to the frame 12 and is configured to store a fluid (e.g., hydraulic fluid, etc.) throughout the refuse vehicle 10. The fluid container 200 includes a fluid outlet port 202. The fluid outlet port 202 facilitates fluid from the fluid container 100 downstream to a location on the refuse vehicle 10. The fluid container 200 includes an inlet port 204. The inlet port 204 is configured to receive fluid returning from the location on the refuse vehicle 10. In some embodiments, the fluid container 200 is configured such that the inlet port 204 is located where the fluid outlet port 202 is and vice versa. In some embodiments, the fluid container 200 is fluidly coupled to a filter assembly that is positioned externally from the fluid container. In some embodiments, the fluid container 200 is a component of the hydraulic system of the refuse vehicle 10.

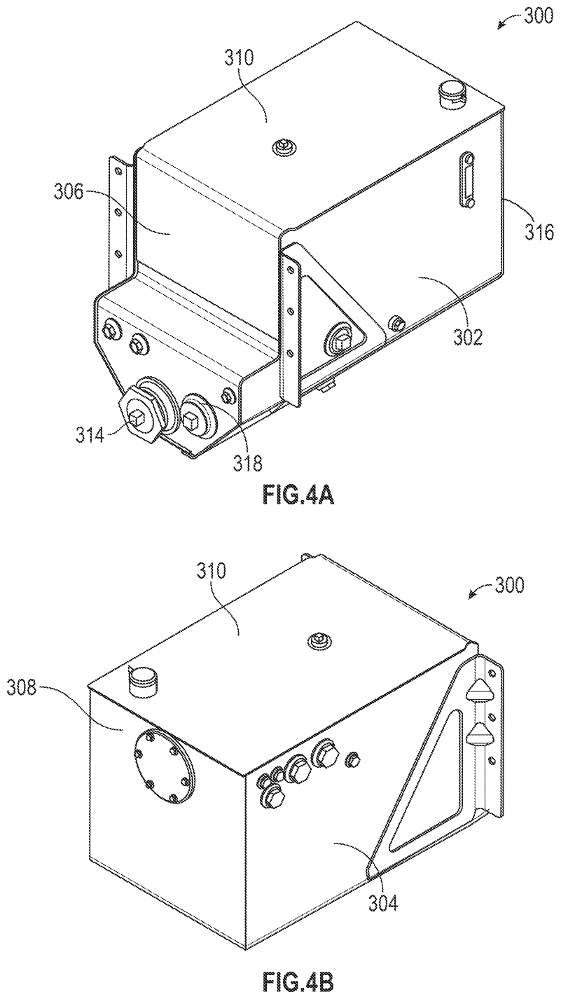

Referring to FIG. 4A and 4B, a fluid container 300 (e.g., a hydraulic reservoir, a fluid container, etc.), according to one embodiment is shown. In some embodiments, the fluid container 300 is the same as or similar to the fluid container 110 and may be positioned in the location of the fluid container 110 as shown in FIG. 2. FIG. 4A shows a perspective front view of the fluid container 300 and the FIG. 4B shows a rear perspective view of the fluid container 300. Unlike the fluid container 200 of FIG. 3, the fluid container 300 may, beneficially, reduce the volume necessary for operation and increase the availability of space by having a reduced reservoir size. Further, the fluid container 300 is coupled to the frame 12 similarly to the fluid container 110. Beneficially, the arrangement of the fluid container 300 as shown in FIG. 2, facilitates a set fluid container location, which may simplify manufacturability and serviceability. The fluid container 300 is configured to store fluid (e.g., hydraulic fluid, etc.) which is then provided to components on the refuse vehicle 10 via a plurality of pipes, as described herein. The fluid container 300 includes a first sidewall 302, a second sidewall 304, a front wall 306, a back wall 308, a top wall 310, and a bottom wall. The first sidewall 302 is contiguous with the front wall 306, the back wall 308, the top wall 310, and the bottom wall. The second sidewall 304 is contiguous with front wall 306, the back wall 308, the top wall 310, and the bottom wall. The plurality of walls defines a fluid container body 316. The fluid container body 316 defines a void, inner volume, or space that is configured to store the fluid. In some embodiments, the void is configured to store fluid amount (e.g., a fluid volume, etc.,) approximately in a range between 35 gallons (gal.) to 45 gal. (e.g., 35 gal., 35.5 gal., 36 gal., 36.5 gal., 37 gal., 37.5 gal., 38 gal., 38.5 gal., 39 gal., 39.5 gal., 40 gal., 40.5 gal., 41 gal., 41.5 gal., 42 gal., 42.5 gal., 43 gal., 43.5 gal., 44 gal., 44.5 gal., 45 gal., etc.). The fluid container 300 includes a filter element disposed within the void. The filter element is configured to filter the fluid of contaminants within the void. The arrangement of integrating the filter element within the fluid container 300, beneficially, reduces potential failure points/modes and enhances ability to service the filter element. In some embodiments, the fluid container 300 is configured to receive various filter elements. The fluid container 300 may include a remote breather. The remote breather may be configured to release any pressure build up within the fluid container 300. In some embodiments, the fluid container may include a telematics filter bypass sensor. The telematics filter bypass sensor is disposed within the fluid container 300 and is configured to facilitate flow of the fluid so as to bypass the filter. The telematics filter bypass sensor may be controlled remotely by an operator.

The fluid container 300 includes a suction port 314. The suction port 314 (e.g., inlet port, outlet port, etc.) is formed on the front wall 306. In some embodiments, the suction port 314 is formed on any of the first sidewall 302, the second sidewall 304, the front wall 306, the back wall 308, the top wall 310, and the bottom wall. The suction port 314 may be configured to facilitate flow of the fluid from within the void of the fluid container 300 downstream, as described herein. In some embodiments, the suction port 314 is configured to receive fluid from a downstream location and facilitate the fluid into the fluid container 300. The suction port 314 may include a fastening means (e.g., threads, pipe threads (NPT standard), etc.) for fastening a pipe. The pipe facilitates the flow of the fluid from the fluid container downstream. The fluid container 300 includes a heater port 318 (e.g., inlet port, outlet port, etc.). The heater port 318 is formed on the front wall 306 and is proximate to the suction port 314. In some embodiments, the heater port 318 is formed on any of the first sidewall 302, the second sidewall 304, the front wall 306, the back wall 308, the top wall 310, and the bottom wall. The heater port 318 may include a fastening means (e.g., threads, pipe threads (NPT standard), etc.) for fastening a pipe. In some embodiments, the fluid container 300 is configured such that the heater port 318 is located where the suction port 314 is and vice versa. The heater port 318 may be configured to receive fluid returning from a location downstream of the fluid container. In some embodiments, the heater port 318 is configured to facilitate flow of the fluid from within the void of the fluid container 300 downstream. The heater port 318 is configured to facilitate the removal or egress of the heat from the fluid flowing through the heater port 318. In some embodiments, the fluid container 300 may include baffling and serviceable fittings. In some embodiments, the fluid container 300 is a component of the hydraulic system of the refuse vehicle 10.

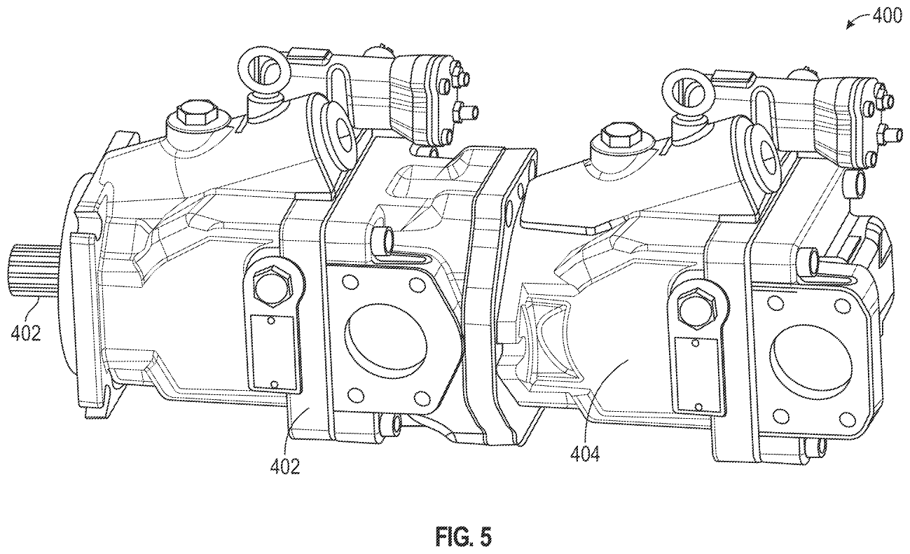

Referring to FIG. 5, a perspective view of a pump 400 is shown. The refuse vehicle 10 includes the pump 400. In some embodiments, the pump 400 is a component of the hydraulic system of the refuse vehicle 10. The pump 400 is fluidly coupled to the fluid container (e.g., fluid container 110, fluid container 200, etc.). The pump 400 is configured to pump the fluid stored within the fluid container 300 to a location downstream on the refuse vehicle 10. The pump 400 includes a first pump 402 and a second pump 404. The first pump 402 is coupled to the second pump 404 to form a single pump 400. The pump 400 is used in both residential and commercial applications. The pump 400 includes an inlet 406 and an outlet. The inlet 406 is formed on the first pump 402 and the outlet is formed on the second pump 404. The inlet 406 is configured to receive fluid from the fluid container and the outlet is configured to discharge the fluid downstream as the pump is in operation. In some embodiments, the second pump 404 is a component of the hydraulic system. In some embodiments, the second pump 404 is smaller than the first pump 500 and provides additional assistance or pressurization of the fluid in combination with the first pump 500. The first pump 500 can include a flange 506 including openings to couple (e.g., fasten) the second pump 404 with the first pump 500.

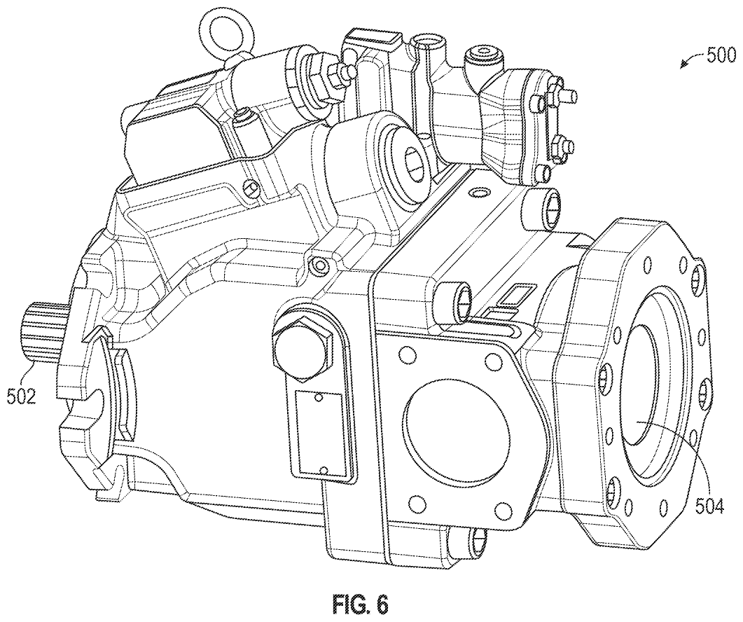

Referring to FIG. 6, a perspective view of pump 500 is shown. The pump 500 is configured to pump fluid from the fluid container to a location downstream on the refuse vehicles. In some embodiments, the location downstream is an actuator assembly, which receives the fluid. Specifically, as the pump 500 pumps the fluid to the actuator assembly, an actuator is operated from a first position (e.g., closed position, retracted position, etc.) to a second position (e.g., open position, extracted position, etc.). Unlike the pump 400 as shown in FIG. 5, the pump 500 may be a single pump used in commercial refuse vehicle, which, beneficially, reduce failures while ensuring sufficient supply and reduces complexity of manufacturing of various refuse vehicles 10. The pump 500 includes an inlet 502. The inlet 502 is fluidly coupled to the fluid container (e.g., fluid container 110, fluid container 300, etc.) and configured to receive fluid from the fluid container as the pump 500 is operated. The pump 500 includes an outlet 504. The outlet 504 is fluidly coupled to a pipe, as described herein and is configured to discharge fluid received by the inlet 502 to a location downstream on the refuse vehicle 10. In some embodiments, the pump 500 is a component of the hydraulic system of the refuse vehicle 10.

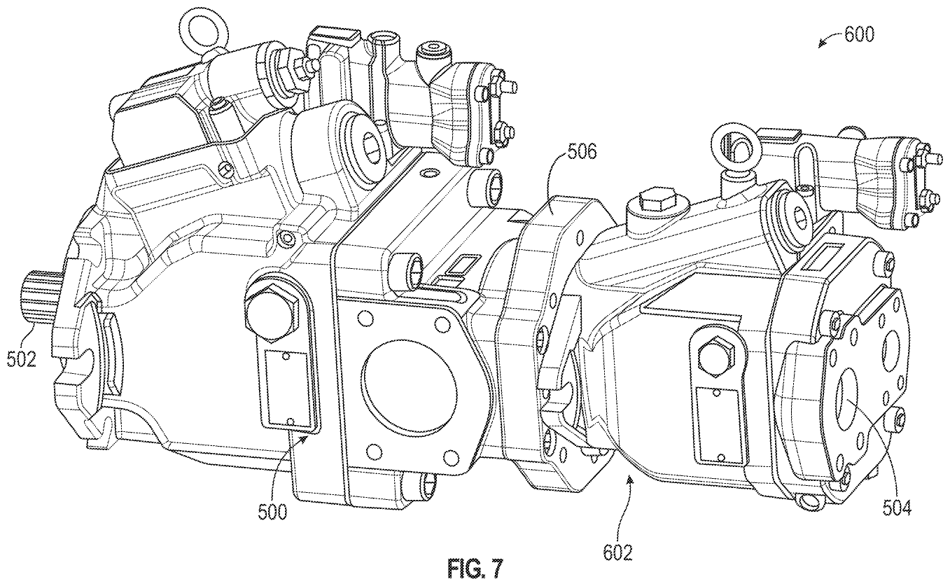

Referring to FIG. 7, a perspective view of a pump assembly 600 is shown. The pump assembly 600 includes the pump 500 and a second pump 602. Unlike the pump 400 as shown in FIG. 5, the pump assembly 600 includes the second pump 602, which is designed specifically for residential use. Beneficially, this arrangement facilitates ease of serviceability, reduction of failure, and simplification of manufacturing. The second pump 602 is coupled to the pump 500. Specifically, the second pump inlet is coupled to the outlet 504 of the pump 500 such that fluid flows from the pump 500 into the second pump 602. The second pump 602 includes a second pump outlet 604 (e.g., opening, nozzle, etc.) configured to facilitate flow of the fluid downstream. In some embodiments, the pump assembly 600 is a component of the hydraulic system of the refuse vehicle 10.

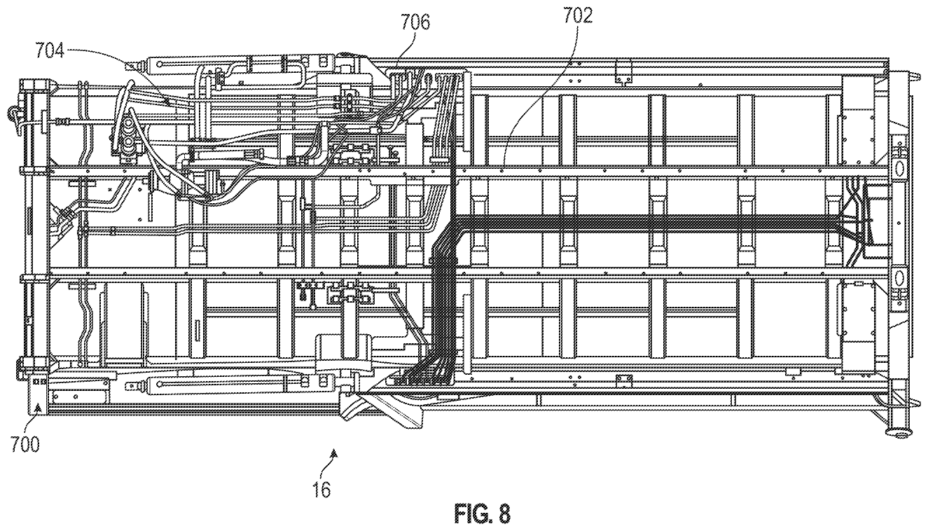

Referring to FIG. 8 a perspective view of a portion of the on-board refuse container 16, according to one embodiment is shown. Specifically, FIG. 8 depicts a wall 700 (e.g., first wall, second wall, top wall, bottom wall, etc.,) of the on-board refuse container 16, according to one embodiment. The on-board refuse container 16 includes a first rail 702. The first rail 702 extends along the wall in a longitudinal direction and is coupled to the wall 700. The on-board refuse container 16 includes a plurality of pipes 704 (e.g., conduits, hoses, etc.). The plurality of pipes is fluidly coupled to the pump 400 and the fluid container 200 and configured to receive fluid from the fluid container 200. The plurality of pipes 704 extend across and along the wall 700 substantially between the first rail 702 and an edge 706 of the wall 700. Further, at least two of the plurality of pipes 704 may overlap (e.g., cross, etc.). In some embodiments, the pipes 704 are components of the hydraulic system of the refuse vehicle 10.

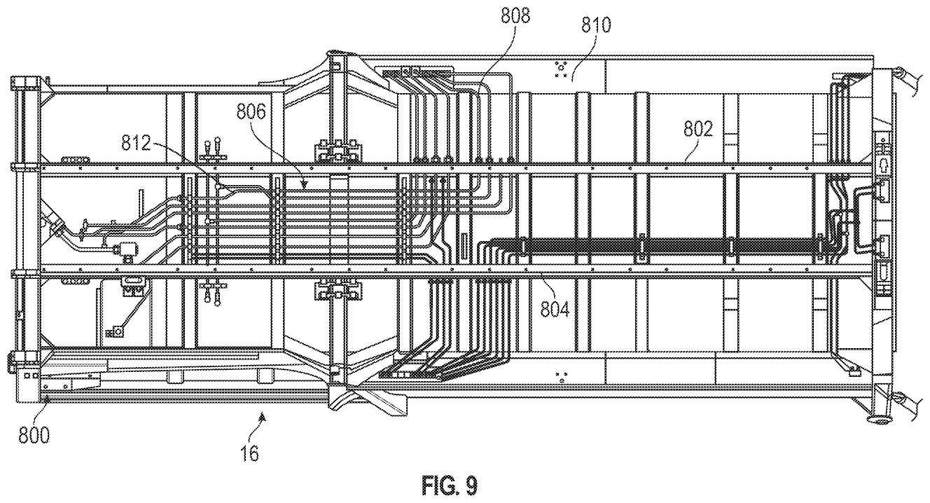

Referring to FIG. 9, a bottom view of a portion of the on-board refuse container 16, according to one embodiment, is shown. Specifically, FIG. 9 depicts a wall 800 (e.g., first wall, second wall, top wall, bottom wall, etc.,) of the on-board refuse container 16. In some embodiments, the wall 800 is the bottom wall of the on-board refuse vehicle and is configured to abut the frame 12. The on-board refuse container 16 includes a first rail 802. The first rail 802 is coupled to the wall 800 and extends in a longitudinal direction along the wall 800. The on-board refuse container 16 includes a second rail 804. The second rail 804 is substantially similar to the first rail 802. In some embodiments, the first rail 802 and the second rail 804 components of the body 14 (e.g., the on-board refuse container 16). In some embodiments, the first rail 802 and the second rail are rails of the chassis 12. The second rail is spaced laterally apart from the first rail 802. The on-board refuse container 16 includes a plurality of pipes 806 (e.g., body plumbing, etc.). The plurality of pipes 806 are configured to facilitate flow of fluid to and from the fluid container 300. Each of the plurality of pipes 806 include a first pipe portion 808. The first pipe portion 808 is fluidly coupled to the fluid container 300. In some embodiments a configured to receive fluid from the fluid container 300. In some embodiments, the first pipe portion 808 is configured to provide fluid from a location downstream to the fluid container 300.

The first pipe portion 808 may be fluidly coupled to the pump (e.g., pump 500, pump assembly 600, etc.). The first pipe portion 808 extends toward the first rail 802 in a lateral direction across the wall 800. In some embodiments, the first pipe portion 808 extends toward the second rail 804 in a lateral direction across the wall 800. Each of the plurality of pipes 806 include a second pipe portion 812. The second pipe portion 812 fluidly coupled to the first pipe portion 808. The second pipe portion 812 is configured to receive fluid from the first pipe portion 808 and facilitate flow of the fluid downstream. In some embodiments, the second pipe portion 812 is configured to facilitate flow of the fluid from the second pipe portion 812 to the first pipe portion 808 such that the fluid may be returned to the fluid container 300. The second pipe portion substantially extends along the wall 800 in a longitudinal direction and is spaced laterally from the first rail 802 and the second rail 804 so as to be between the first rail 802 and the second rail 804. In some embodiments, the second pipe portions 812 extend in a direction that is perpendicular to a direction of the first pipe portions 808 (e.g., in a longitudinal direction) between the first rail 802 and the second rail 804. In some embodiments, the first pipe portions 808 and the second pipe portions 812 extend through the first rail 802 and/or the second rail 804 through hydraulic connectors or tubular members that extend through the first rail 802 and/or the second rail 804.

Unlike the plurality of pipes 704 as shown in FIG. 8, the plurality of pipes 806 as shown in and described with reference to FIG. 9, advantageously facilitate various axle configurations, provide a set layout for various refuse vehicle configurations, simplify the design for the fluid container (e.g., hydraulic container design, etc.), the serviceability of the components on the refuse vehicle 10, and the manufacturability of the refuse vehicle 10, and facilitate the plurality of pipes 806 to be centralized and communized. For example, the plurality of pipes 806 are configured such that overlapping of each of the plurality of pipes 806 is reduced.

The second pipe portion 812 may be coupled to an actuator located at the location downstream and facilitates flow of the fluid to the actuator. In an exemplary embodiment, the actuator receives the fluid from the second pipe portion 812 which facilitate the actuator to move (e.g., extend, etc.) from a first position (e.g., retracted position, closed position, etc.,) to a second position (e.g., extended position, open position, etc.). In some embodiments, the second pipe portion 812 is configured to receive the fluid from the actuator when the actuator is operated from the second position to the first position.

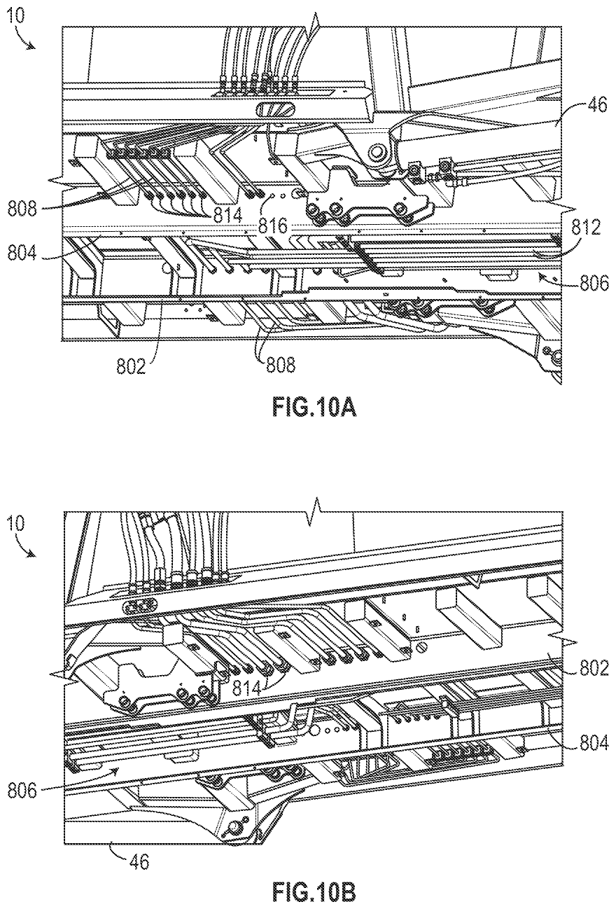

Referring to FIGS. 10A and 10B, the pipes 806 may extend through the first rail 802 and/or the second rail 804. In some embodiments, the first rail 802 and/or the second rail 804 include an array of openings 816 (e.g., bores, holes, through-holes, etc.) disposed along the first rail 802 and the second rail 804. In some embodiments, the first rail 802 and the second rail 804 include a connector 814 that extends through the openings 816 and provides a fluid flow path through the first rail 802 and the second rail 804. In some embodiments, the connector 814 includes a tubular member that extends through the openings 816. The connector 814 may also include a connection interface on either side in order to facilitate connection of different segments of the pipes 806 (e.g., the first pipe portions 808 and the second pipe portions 812) through the connectors 814. In some embodiments, the connectors 814 include quick connect-disconnect interfaces on either end. In some embodiments, the connectors 814 are configured to threadingly engage or couple with ends of the different segments of the pipes 806 on either side of the connectors 814. The connectors 814 can be positioned along the first rail 802 and the second rail 804 at standard or predetermined locations such that the pipes 806 can be routed to the connectors 814. In some embodiments, the connectors 814 facilitate providing a fluid flow path for supply or return lines of the pipes 806 through the first rail 802 and/or the second rail 804. In some embodiments, providing fluid flow paths through the first rail 802 and/or the second rail 804 provides a streamlined and more compact arrangement of fluidic members (e.g., conduits). For example, the pipes 806 do not need to be routed around the first rail 802 and/or the second rail 804 and instead can be easily coupled with the connectors 814. Further, the connectors 814 and the openings 816 are manufactured on the first rail 802 and/or the second rail 804 which reduces a likelihood that a technician will drill holes in the first rail 802 and/or the second rail 804 to pass a hydraulic line through. It should be understood that the first rail 802 and the second rail 804 may be components of the body 14 or the chassis 12. In some embodiments, frame rails of the chassis 12 also include connectors 814 similar to the connectors 814 described herein such that the pipes 806 can be routed through the frame rails of the chassis 12.

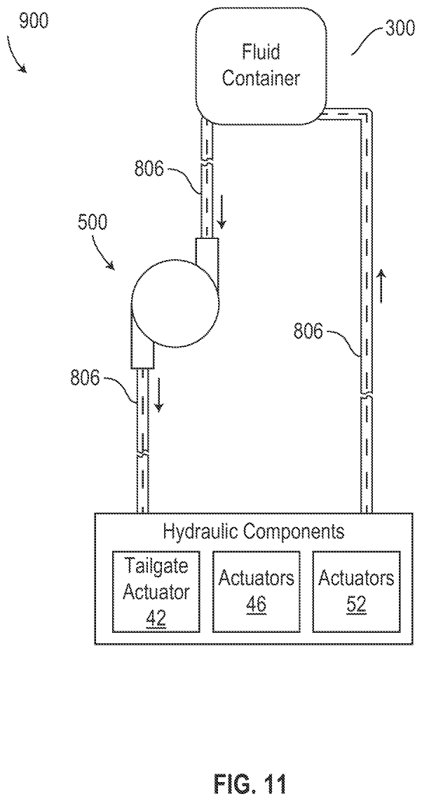

Referring to FIG. 11, the various hydraulic or fluidic components of the refuse vehicle 10 can be provided as a hydraulic system 900. In some embodiments, the hydraulic system 900 includes the fluid container 300, the pump 500, one or more hydraulic components of the refuse vehicle 10, shown as tailgate actuator 42, actuators 46, and actuators 52, and the pipes 806. The pump 500 is configured to receive fluid from the fluid container 300, pressurize the fluid, and discharge the fluid to the hydraulic components of the refuse vehicle 10 (e.g., the tailgate actuator 42, the actuators 46, the actuators 52, etc.). The hydraulic components of the refuse vehicle 10 may receive the hydraulic fluid from the pump 500 and operate to extend or retract to perform a function of the refuse vehicle 10. In some embodiments, the hydraulic system 900 includes the pump assembly 600 in place of the pump 500.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

References herein to the positions of elements (e.g., “first”, “second”, “third”, etc.,) are used to distinguish one element from another element without necessarily requiring or implying any actual such relationship or order. It should be noted that the orientation of various elements may differ according to other exemplary embodiments, and that such variations are intended to be encompassed by the present disclosure.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle, comprising:
a chassis;
a body coupled with the chassis comprising a first frame rail and a second frame rail spaced apart from each other in a lateral direction and extending in a longitudinal direction along a bottom of the body;
a hydraulic system comprising:
a pump configured to pressurize a fluid;
a hydraulic cylinder configured to receive the fluid and extend or retract; and
a hydraulic line configured to fluidly couple with an outlet of the pump and an inlet of the hydraulic cylinder, the hydraulic line configured to extend laterally through the first frame rail by fluidly coupling with a connector that extends through an opening in the first frame rail, a portion of the hydraulic line extending in the longitudinal direction between the first frame rail and the second frame rail from the connector to the hydraulic cylinder.

2. The refuse vehicle of claim 1, wherein the hydraulic system comprises:
a plurality of the hydraulic lines fluidly coupled with the outlet of the pump, wherein two or more of the plurality of hydraulic lines are configured to extend laterally through corresponding connectors of the first frame rail by fluidly coupling with the corresponding connectors that extend through corresponding openings in the first frame rail, wherein a portion of the two or more of the plurality of hydraulic lines extend in the longitudinal direction between the first frame rail and the second frame rail from the corresponding connectors to two or more hydraulic cylinders.

3. The refuse vehicle of claim 1, wherein the hydraulic cylinder is configured to extend or retract to drive a lift arm of the refuse vehicle to perform a refuse operation of the refuse vehicle.

4. The refuse vehicle of claim 1, wherein the hydraulic cylinder is a tailgate cylinder configured to extend or retract to drive a tailgate of the body to rotate between an open position and a closed position.

5. The refuse vehicle of claim 1, wherein the hydraulic line extends in the longitudinal direction between the first frame rail and the second frame rail from the connector to the hydraulic cylinder to provide clearance between the body and the chassis, wherein the body is configured to be coupled on a plurality of different chassis having different axle configurations without the hydraulic line interfering with components of the plurality of different chassis.

6. The refuse vehicle of claim 1, wherein the pump is a first pump for a commercial configuration of the refuse vehicle, the first pump configured to couple with a second pump in series for a residential configuration of the refuse vehicle, the second pump configured to pressurize fluid for a plurality of functions specific to the residential configuration of the refuse vehicle.

7. The refuse vehicle of claim 1, wherein the hydraulic system further comprises a hydraulic reservoir comprising an integrated filter positioned within an inner volume of the hydraulic reservoir, the hydraulic reservoir fluidly coupled with an inlet or suction of the pump and positioned on a laterally outwards side of a frame rail of the chassis that extends in the longitudinal direction.

8. The refuse vehicle of claim 7, wherein the chassis comprises:
a first axle coupled to chassis and spaced laterally apart from the hydraulic reservoir; and
a pusher axle coupled to the chassis and spaced longitudinally apart from the first axle such that the pusher axle is positioned between the first axle and the hydraulic reservoir.

9. A hydraulic system for a refuse vehicle, the hydraulic system comprising:
a pump configured to pressurize a fluid;
a hydraulic cylinder configured to receive the fluid and extend or retract; and
a hydraulic line configured to fluidly couple with an outlet of the pump and an inlet of the hydraulic cylinder, the hydraulic line configured to extend laterally through a first frame rail of the refuse vehicle by fluidly coupling with a connector that extends through an opening in the first frame rail, a portion of the hydraulic line extending in a longitudinal direction between the first frame rail and a second frame rail from the connector to the hydraulic cylinder.

10. The hydraulic system of claim 9, wherein the first frame rail and the second frame rail are frame rails of a body of the refuse vehicle that extend in the longitudinal direction along a bottom of the body of the refuse vehicle.

11. The hydraulic system of claim 9, wherein the hydraulic system comprises:
a plurality of the hydraulic lines fluidly coupled with the outlet of the pump, wherein two or more of the plurality of hydraulic lines are configured to extend laterally through corresponding connectors of the first frame rail by fluidly coupling with the corresponding connectors that extend through corresponding openings in the first frame rail, wherein a portion of the two or more of the plurality of hydraulic lines extend in the longitudinal direction between the first frame rail and the second frame rail from the corresponding connectors to two or more of the hydraulic cylinders.

12. The hydraulic system of claim 9, wherein the hydraulic cylinder is configured to extend or retract to drive a lift arm of the refuse vehicle to perform a refuse operation of the refuse vehicle.

13. The hydraulic system of claim 9, wherein the hydraulic cylinder is a tailgate cylinder configured to extend or retract to drive a tailgate of a body of the refuse vehicle to rotate between an open position and a closed position.

14. The hydraulic system of claim 9, wherein the hydraulic line extends in the longitudinal direction between the first frame rail and the second frame rail from the connector to the hydraulic cylinder to provide clearance between a body and a chassis of the refuse vehicle, wherein the body is configured to be coupled on a plurality of different chassis having different axle configurations without the hydraulic line interfering with components of the plurality of different chassis.

15. The hydraulic system of claim 9, wherein the pump is a first pump for a commercial configuration of the refuse vehicle, the first pump configured to couple with a second pump in series for a residential configuration of the refuse vehicle, the second pump configured to pressurize fluid for a plurality of functions specific to the residential configuration of the refuse vehicle.

16. The hydraulic system of claim 9, further comprising a hydraulic reservoir comprising an integrated filter positioned within an inner volume of the hydraulic reservoir, the hydraulic reservoir fluidly coupled with an inlet or suction of the pump and positioned on a laterally outwards side of a frame rail of the chassis that extends in the longitudinal direction.

17. A refuse vehicle, comprising:
a body configured to define an inner volume for storing refuse;
a first frame rail and a second frame rail extending along a bottom of the body in a longitudinal direction, the first frame rail and the second frame rail spaced apart from each other in a lateral direction; and
a hydraulic system comprising:
a pump configured to pressurize a fluid;
a plurality of hydraulic cylinders configured to receive the fluid and extend or retract; and
a plurality of hydraulic lines fluidly coupled with an outlet of the pump and inlets of the plurality of hydraulic cylinders, the plurality of hydraulic lines configured to extend laterally through the first frame rail by fluidly coupling with a plurality of connectors that extend through a plurality of openings in the first frame rail, a portion of the plurality of hydraulic lines extending in the longitudinal direction between the first frame rail and the second frame rail from the plurality of connectors to the plurality of hydraulic cylinders.

18. The refuse vehicle of claim 17, wherein the plurality of hydraulic cylinders comprises at least one of a lift arm cylinder configured to drive a lift arm of the refuse vehicle to perform a refuse operation, or a tailgate cylinder configured to extend or retract to drive a tailgate of the refuse vehicle to rotate between an open position and a closed position.

19. The refuse vehicle of claim 17, wherein the pump is a first pump for a commercial configuration of the refuse vehicle, the first pump configured to couple with a second pump in series for a residential configuration of the refuse vehicle, the second pump configured to pressurize fluid for a plurality of functions specific to the residential configuration of the refuse vehicle.

20. The refuse vehicle of claim 17, further comprising a hydraulic reservoir comprising an integrated filter positioned within an inner volume of the hydraulic reservoir, the hydraulic reservoir fluidly coupled with an inlet or suction of the pump and positioned on a laterally outwards side of a frame rail of the chassis that extends in the longitudinal direction.
